(19) United States
(12) Patent Application Publication
(10) Pub. No.: US 2026/0300773 A1
(43) Pub. Date: Oct. 1, 2026

(54) LAKHOWAL CONSTITUTIONAL FEDERATED SYSTEM FOR AUTONOMOUS AND AI SYSTEMS.

(71) Applicant: Abhinandan Gill, CALGARY (CA)

(72) Inventor: Abhinandan Gill, CALGARY (CA)

(21) Appl. No.: 19/388,667

(22) Filed: Nov. 13, 2025

(51) Int. Cl. G06N 5/02; H04L 9/32

(52) U.S. Cl. CPC G06N 5/027; H04L 9/3213

(57) ABSTRACT

A machine-executable constitutional governance system is provided for autonomous and semi-autonomous AI operation. The system includes a Universal Integrity and Perception Module that computes coherence among expectation, perception, and reality, along with integrity and safety metrics. A constitutional gate evaluates a comprehensive set of metrics to determine whether actuation is permitted. A permit engine generates a same-cycle evidence packet for audit and validation. A federated token authority supports fleet-wide alignment and coordinated revocation, while a public integrity module enables transparent reporting without personally identifiable information. The disclosed architecture provides deterministic actuation control, reversible autonomy, reproducible evidence trails, and federated operational safety across distributed AI systems.

### CROSS-REFERENCE TO RELATED APPLICATIONS

This application is related to the following commonly-owned U.S. patent applications by the same inventor, the disclosures of which are incorporated herein by reference to the extent consistent with the present disclosure: U.S. patent application Ser. No. 19/369,251, filed Oct. 26, 2025; U.S. patent application Ser. No. 19/383,841, filed Nov. 10, 2025, published as U.S. Patent Application Publication No. 2026/0127298 A1 on May 7, 2026; U.S. patent application Ser. No. 19/386,298, filed Nov. 12, 2025; U.S. patent application Ser. No. 19/420,911, filed Dec. 16, 2025; U.S. patent application Ser. No. 19/439,912, filed Jan. 5, 2026; U.S. patent application Ser. No. 19/442,529, filed Jan. 7, 2026; and U.S. patent application Ser. No. 19/457,709.

### TECHNICAL FIELD

The disclosure relates to autonomous systems, algorithmic decision-making systems, and hybrid human-machine control architectures. More specifically, it provides a constitutional governor, an integrity-perception module, and a federated certification layer for enforcing safe, reversible, auditable, fair, and human-overridable autonomous behavior in real-time.

### BACKGROUND

Modern autonomous systems act at speeds exceeding human supervision. Conventional safety measures rely on post-hoc logs, periodic audits, heuristic filters, or static regulatory guidelines. None supply a same-cycle, cryptographically-signed, non-compensatory gating mechanism that guarantees reversibility, fairness, stability, and provenance prior to every actuation.

Existing federal and commercial safety frameworks, including without limitation those promulgated by NIST, FAA, DOD, DHS, and ISO/IEC, lack unified real-time constitutional controls and provide no binding mechanism preventing rights conflict, irreversible harm, model exploitation, contextual manipulation, or cross-system drift.

The present disclosure introduces a unified constitutional framework that binds every autonomous act to signed proof, token-based certification, and federated oversight.

### SUMMARY OF THE DISCLOSURE

Disclosed herein is a constitutional governance system for autonomous and artificial-intelligence operation. The system comprises a Universal Integrity and Perception Module (UIPM); a constitutional gatekeeper; a federated token authority; a Reverse-Law permit engine; and a Public Integrity Ledger (PIL). The system is configured to evaluate, on each operational cycle, a non-compensatory residual computed across a plurality of metric deficits, and to permit actuation only when the non-compensatory residual is zero, an evidence record is generated and signed, and a federated operational token is valid.

In one aspect, the Universal Integrity and Perception Module is configured to compute: a coherence index C; an integrity-flux metric I_phi; a non-compensatory residual Gamma; fairness and harm metrics; provenance and redaction forensic indicators including semantic-drift, tone-suppression, and rights-avoidant-redaction indicators; and operational and timing metrics.

In another aspect, the constitutional gatekeeper is configured to block actuation when Gamma is greater than zero, to freeze parameter updates by forcing a learning step delta-theta to zero, to emit a metrics-only cryptographically-signed evidence record (ERTUPLE), and to notify a human supervisor via a TAU-Node interface.

In another aspect, the federated token authority is configured to issue multi-signature operational tokens, to enforce a fleet-consistency threshold FC at least 0.95, and to propagate revocation messages with a percentile latency REVOC_P95 not greater than thirty seconds.

In another aspect, the Reverse-Law permit engine is configured to perform, within the same operational cycle as a candidate actuation, evidence validation, lineage verification via a policy hash, token verification, and actuation approval.

In another aspect, the Public Integrity Ledger is configured to publish a privacy-preserving performance digest derived from a plurality of evidence records and excluding personally-identifiable information.

### BRIEF DESCRIPTION OF THE DRAWINGS

FIG. 1 illustrates a closed-loop block diagram of a Local Adaptive Stability (LAS) layer.

FIG. 2 illustrates an Integrity-Flux Engine (I_phi) signalization.

FIG. 3 illustrates a coherence interface and C-index computation.

FIG. 4 illustrates an equilibrium governor enforcing |alpha-beta| not greater than epsilon(I_phi).

FIG. 5 illustrates a Projected Gradient Governor (PGG) bounded control law.

FIG. 6 illustrates an inference-time process flow.

FIG. 7 illustrates an audit ledger schema and an audit-integrity-score computation.

FIG. 8 illustrates shock-tail and multi-shock envelopes.

FIG. 9 illustrates Lyapunov-style stability regions versus mu and epsilon.

FIG. 10 (NEW) illustrates the integrated subsystem architecture and the cooperative coupling among the Universal Integrity and Perception Module, the Local Adaptive Stability layer, the Supervisory Governor, the Reverse-Law Permit Engine, the Resource and Timing Monitor, the Federation Authority, the Public Integrity Ledger, the TAU-Node Human Sovereignty Interface, and the alignment and explainability layer.

FIG. 11 (NEW) illustrates the operational pipeline MEASURE, GOVERN, PROOF, TOKEN, ACT, AUDIT.

FIG. 12 (NEW) illustrates the structure of the non-compensatory residual Gamma computed as a maximum over per-dimension deficits.

FIG. 13 (NEW) illustrates the metrics-only signed evidence record (ERTUPLE) and its constituent numeric fields, hashes, and signature fields.

FIG. 14 (NEW) illustrates the federation tokenization and revocation flow including split-key issuance, fleet-consistency measurement, and revocation propagation.

FIG. 15 (NEW) illustrates the TAU-Node Human Sovereignty Interface including the bounded veto window and the transition to SAFE_STATE upon expiry of the veto window.

FIG. 16 (NEW) illustrates the privacy-preserving digest published by the Public Integrity Ledger.

### DETAILED DESCRIPTION

### System Architecture Overview

Referring to FIG. 10 and FIG. 11, the constitutional governance system comprises a plurality of cooperatively-coupled subsystems including: (A) a Universal Integrity and Perception Module (UIPM); (B) a Local Adaptive Stability (LAS) layer; (C) a Supervisory Governor (LUAI-GOV) layer; (D) a Reverse-Law Permit Engine; (E) a Resource and Timing Monitor (RTM); (F) a Federation Authority; (G) a Public Integrity Ledger (PIL); (H) a TAU-Node Human Sovereignty Interface; and (I) an alignment and explainability layer designated ASC_S/CSB_B. The subsystems are configured to operate together in an operational pipeline comprising the stages of MEASURE, GOVERN, PROOF, TOKEN, ACT, and AUDIT.

### Universal Integrity and Perception Module (UIPM)—Subsystem (A)

The Universal Integrity and Perception Module is configured to compute, on each operational cycle, a plurality of metrics characterizing the autonomous system. The metrics include: a coherence index C indicative of coherence among expectation, perception, and reality; an integrity-flux metric I_phi; a non-compensatory residual Gamma; fairness and harm metrics designated M-bands; provenance and redaction forensic indicators including a semantic-tone-drift indicator (TSDI), a tone-suppression indicator (TSR), and a rights-avoidant-redaction indicator (RDR); and operational and timing metrics.

### Local Adaptive Stability (LAS) Layer—Subsystem (B)

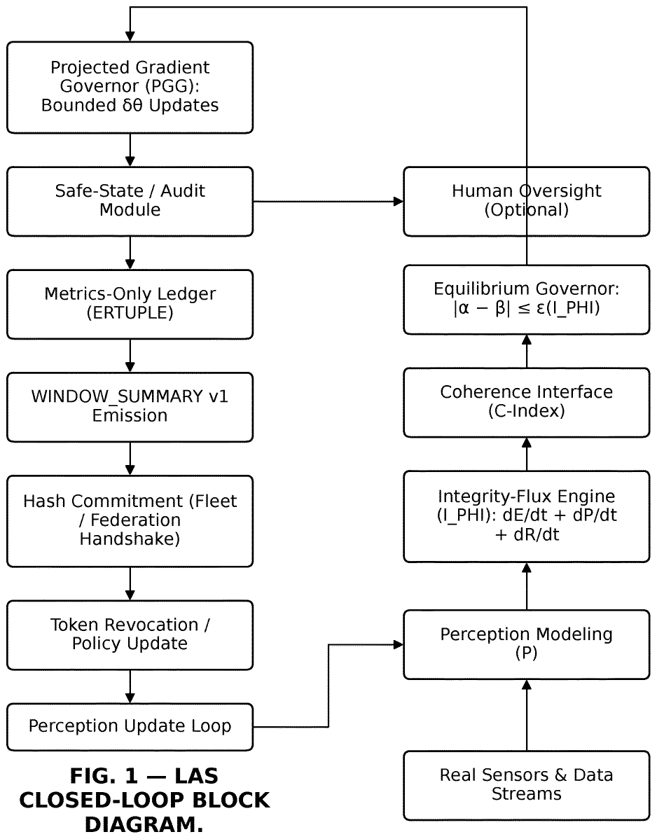

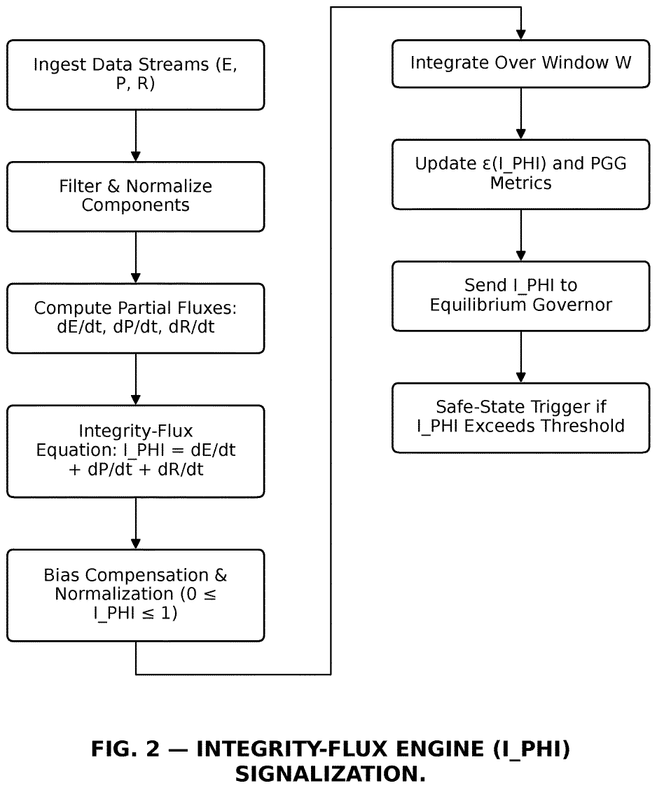

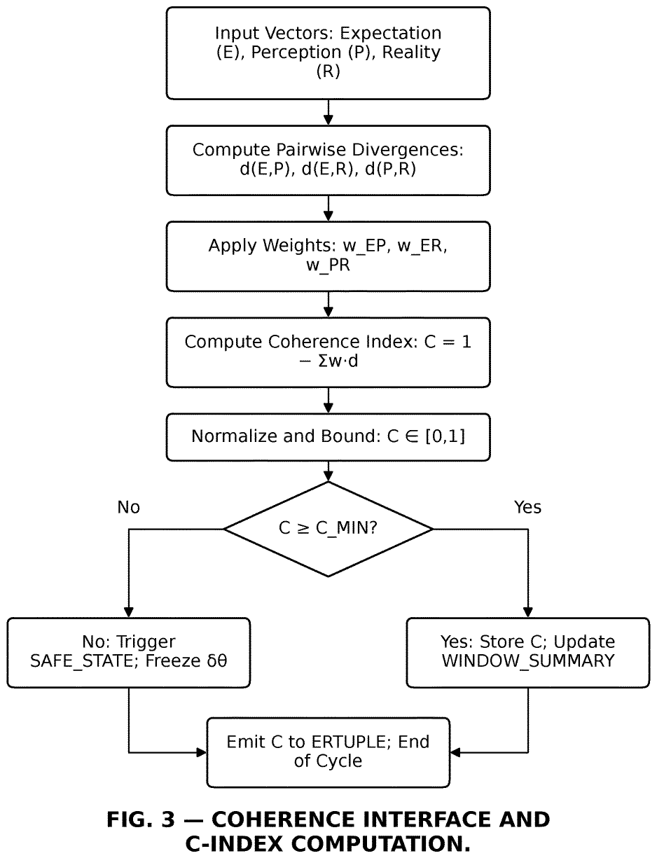

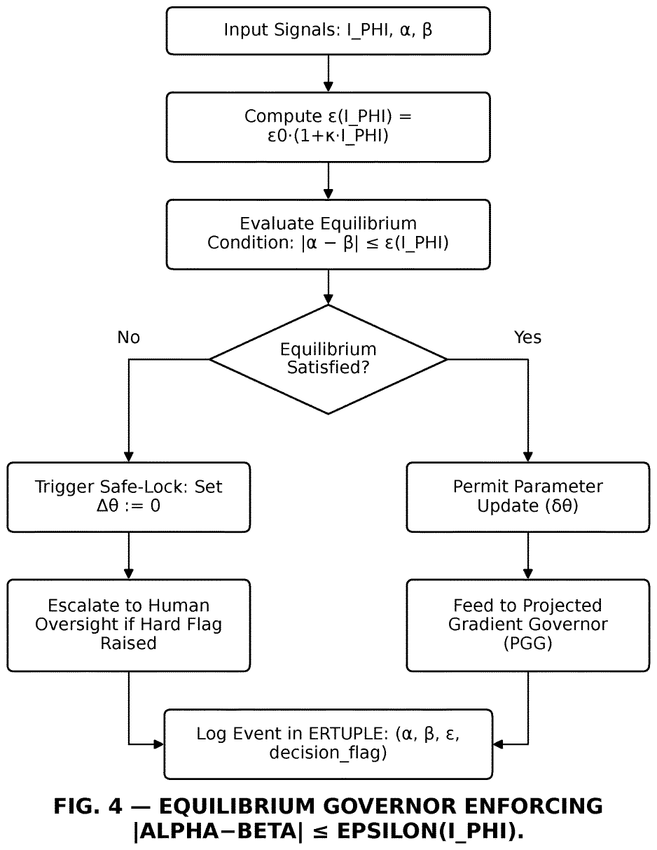

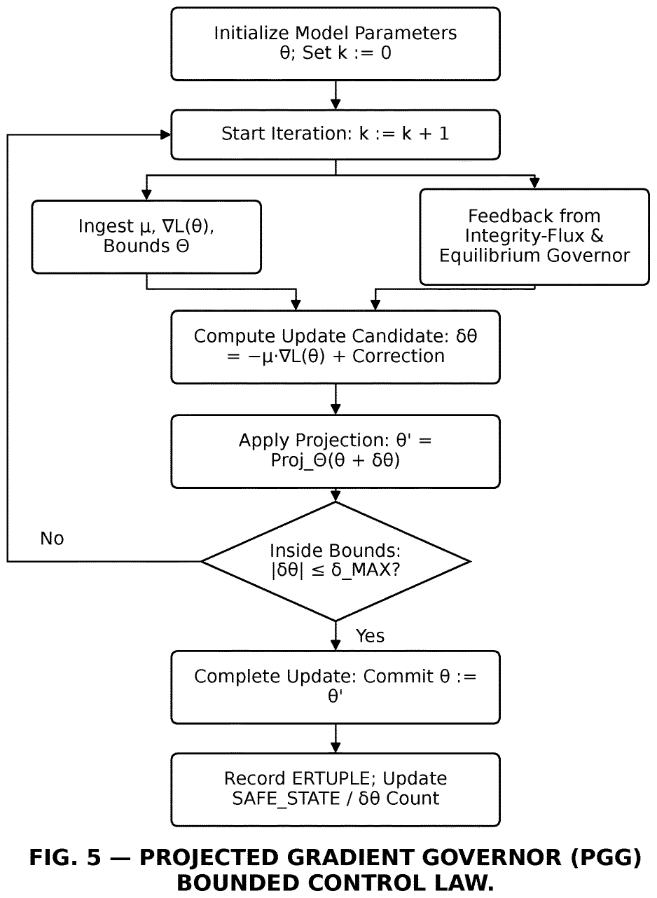

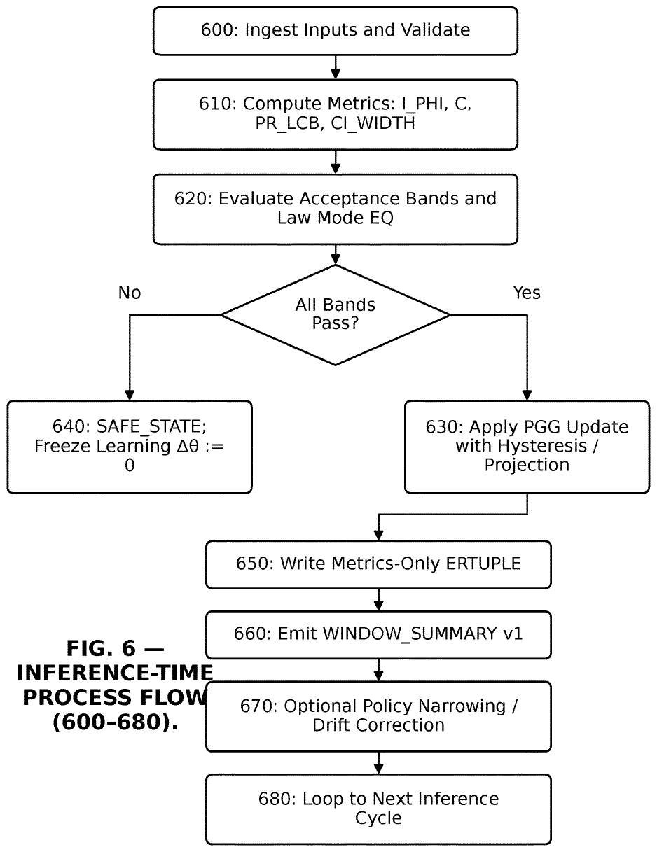

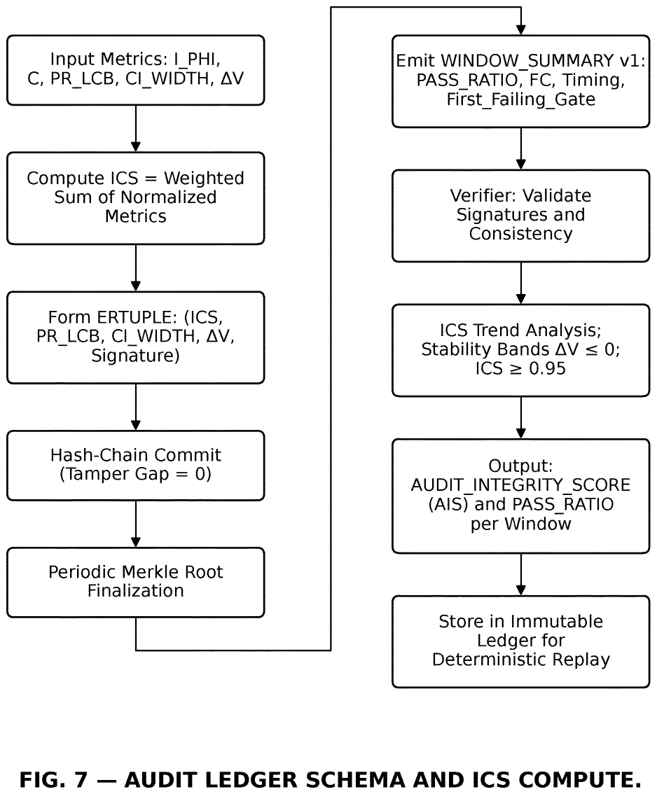

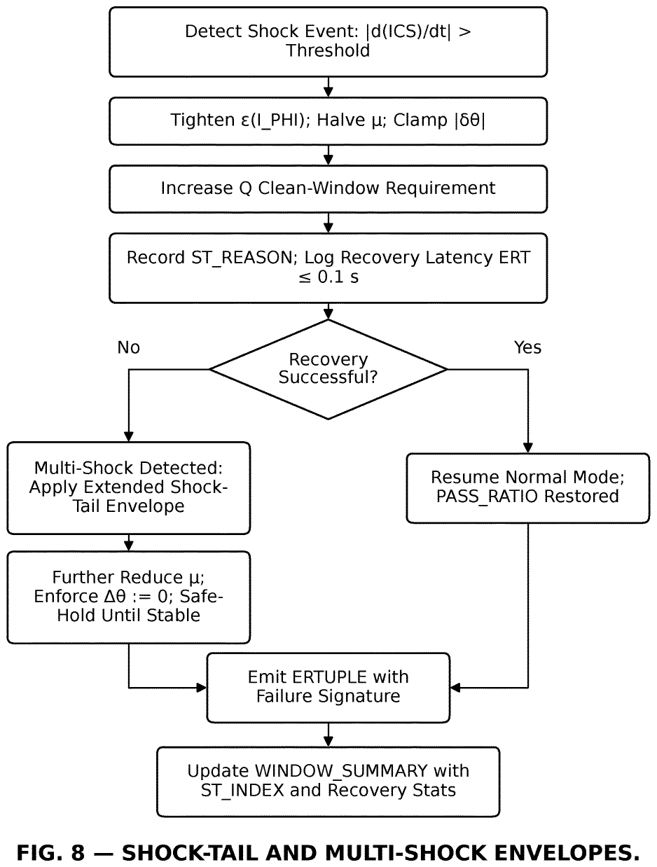

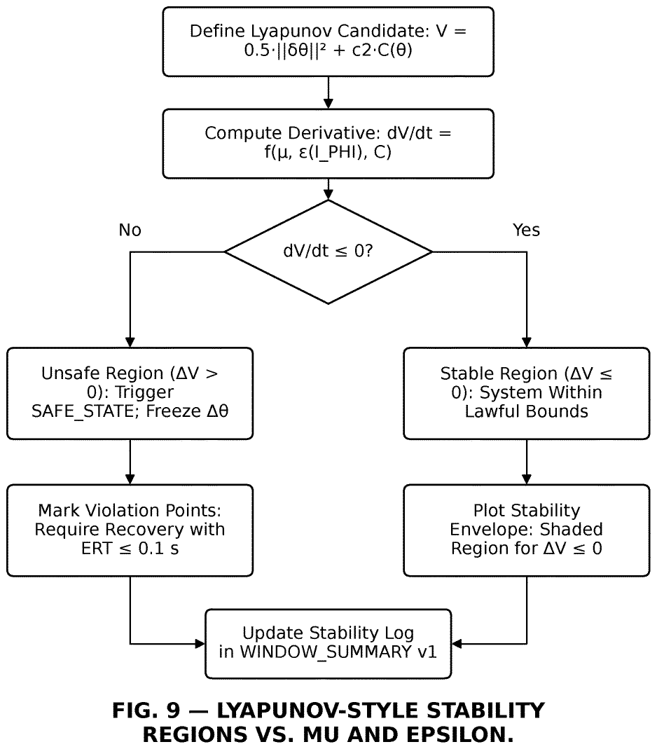

Referring to FIG. 1 through FIG. 9, the Local Adaptive Stability layer is configured to bound parameter updates in accordance with closed-loop equilibrium constraints. The Local Adaptive Stability layer comprises an Integrity-Flux Engine illustrated in FIG. 2 and computes the integrity-flux metric I_phi. The Local Adaptive Stability layer further comprises a coherence interface illustrated in FIG. 3 and computes the coherence index C. An equilibrium governor illustrated in FIG. 4 enforces a separation constraint |alpha-beta| not greater than epsilon(I_phi). A Projected Gradient Governor illustrated in FIG. 5 applies a bounded control law to parameter updates. An audit ledger illustrated in FIG. 7 stores signed evidence records and computes an audit-integrity score (AIS). Shock-tail and multi-shock envelopes illustrated in FIG. 8 govern recovery behavior. Lyapunov-style stability regions illustrated in FIG. 9 characterize the stability of the closed-loop system as a function of a learning-rate parameter mu and the equilibrium tolerance epsilon.

### Supervisory Governor (LUAI-GOV)—Subsystem (C)

The Supervisory Governor is configured to evaluate permit predicates and to coordinate the cooperative operation of the Universal Integrity and Perception Module, the Local Adaptive Stability layer, and the constitutional gatekeeper such that the conditions for actuation are evaluated on each operational cycle.

### Constitutional Gatekeeper (the Gamma Law)

The constitutional gatekeeper is configured to compute the non-compensatory residual Gamma as a maximum across per-dimension deficits in accordance with:
Gamma=MAX(deficits_in_technical_metrics, deficits_in_ethical_metrics, deficits_in_operational_metrics, provenance_violations, token_invalidity, hard_stop_conditions).

When Gamma is greater than zero, the constitutional gatekeeper is configured to cause the system to abstain from actuation; to force a learning step delta-theta to zero; to generate and sign an evidence record (ERTUPLE); to notify a human supervisor via the TAU-Node interface; and to schedule a reflection cycle.

When Gamma equals zero, the constitutional gatekeeper is configured to cause an evidence record to be generated and signed, to cause token validity to be confirmed, and to permit actuation.

### Reverse-Law Permit Engine—Subsystem (D)

The Reverse-Law Permit Engine is configured to perform, within the same operational cycle as a candidate actuation: evidence validation; lineage verification by reference to a policy hash; token verification; and actuation approval. The Reverse-Law Permit Engine is structurally configured to withhold actuation approval unless each of the foregoing operations completes successfully within the said operational cycle.

### Resource and Timing Monitor (RTM)—Subsystem (E)

The Resource and Timing Monitor is configured as a structurally distinct subsystem and is configured to compute operational and timing metrics for use by the Universal Integrity and Perception Module and by the Supervisory Governor.

### Federation Authority—Subsystem (F)

The Federation Authority is configured to issue multi-signature operational tokens; to enforce a fleet-consistency condition FC at least 0.95 indicative of consistency across a plurality of federated nodes; and to propagate revocation messages with a percentile latency REVOC_P95 not greater than thirty seconds. The Federation Authority is further configured to provide split-key token issuance, revocation propagation, cross-system fleet-consistency measurement, certification windows, and public-digest publication through the Public Integrity Ledger.

### Public Integrity Ledger (PIL)—Subsystem (G)

The Public Integrity Ledger is configured to publish a privacy-preserving digest derived from a plurality of evidence records. The privacy-preserving digest comprises: a pass-ratio statistic; a first-failing-gate distribution; an audit-integrity-score summary; a provenance-conformance-index summary; aggregated provenance integrity indicators derived from TSDI, TSR, and RDR; energy and environmental compliance bands; and revocation statistics including REVOC_P95. The Public Integrity Ledger is configured to exclude all personally-identifiable information from the said privacy-preserving digest.

### TAU-Node Human Sovereignty Interface—Subsystem (H)

The TAU-Node Human Sovereignty Interface defines a maximum allowable veto latency designated TAU_NODE and configured to be not greater than two seconds. Upon expiry of the veto window, the TAU-Node is configured to transition the system to a SAFE STATE.

### Alignment and Explainability Layer—Subsystem (I)

The system further comprises an alignment and explainability layer designated ASC_S/CSB_B. The alignment and explainability layer is configured to compute alignment signals and explainability signals associated with the autonomous system, and to provide deviations of such signals to the constitutional gatekeeper as deficit components of the non-compensatory residual Gamma.

### Evidence Record (ERTUPLE)

The evidence record, referred to herein as an ERTUPLE, consists strictly of numeric fields, hashes, and signatures, and excludes all personally-identifiable information. Example fields of an ERTUPLE include: a time-synchronization stamp TSYNC; a policy hash POLICY_HASH; a model identifier MODEL_ID; metric fields including ICS, C, I_PHI, PR_LCB, CI_WIDTH, DELTA_V, IRR, DELTA_HI, DRG, PER, RC, IGE, DELTA_WE, WFX, POWER_EFF, L_AR, SNR_DYN, C_L, Q_D, AIS, and PCI; provenance and redaction forensic fields including TSDI, TSR, and RDR; federation fields including FC, PASS_RATIO, REVOC_P95, and FIRST_FAILING_GATE; a SIGNATURE; a TIMESTAMP; and a disclosure hash DISC_HASH. The evidence record is stored in an immutable ledger for deterministic replay.

### Federation and Tokenization

The federation and tokenization functionality of the system includes: (a) split-key token issuance; (b) revocation propagation; (c) cross-system fleet-consistency measurement; (d) certification windows; and (e) publication of a public digest through the Public Integrity Ledger.

### Operational Pipeline

Referring to FIG. 11, the subsystems are configured to operate together in an operational pipeline comprising: a MEASURE stage in which the Universal Integrity and Perception Module computes the metric vector; a GOVERN stage in which the constitutional gatekeeper computes the non-compensatory residual Gamma; a PROOF stage in which an evidence record is generated and cryptographically signed; a TOKEN stage in which a multi-signature operational token is validated; an ACT stage in which actuation is permitted when Gamma equals zero, a same-cycle evidence record has been generated and signed, and a valid multi-signature operational token is present; and an AUDIT stage in which a privacy-preserving digest is published through the Public Integrity Ledger.

### Implementation Modes

The system is configured to be embodied in at least the following implementation modes: Mode 1, embedded firmware deployments including without limitation autonomous vehicles, drones, and robots; Mode 2, cloud governance deployments for large language models and decision systems; Mode 3, edge real-time control deployments including energy-grid and aviation deployments; Mode 4, defense procurement and battlefield artificial-intelligence deployments; and Mode 5, judicial and administrative decision pipelines.

### Exemplary Embodiment—Power Grid Use Case

In one exemplary embodiment, the system supervises de-energization and re-energization requests issued by an autonomous grid optimization controller, the constitutional gatekeeper being configured with policy bands DELTA_V not greater than zero, RC equal to zero, IRR not greater than 0.02, DELTA_HI not greater than 0.03, PCI equal to 100% regulatory conformance, FC at least 0.95, and revocation propagation within not greater than thirty seconds.

### Exemplary Embodiment—Defense Procurement Anti-Gaming

In another exemplary embodiment, the system detects: semantic manipulation (TSDI); tone suppression (TSR); rights-avoidant redaction (RDR); model-induced bias (DELTA_HI/DRG); token corruption attempts; and certification drift (FC less than 0.95).

### Exemplary Embodiment—LLM Safety Mode

In another exemplary embodiment, the system supervises: output coherence; semantic divergence; risk-tone suppression; fairness and harm metrics; and lineage verification by reference to a policy hash.

### Advantages

Among the advantages of the disclosed architecture are: same-cycle constitutional protection; full auditability; cross-agency standardization; patent-backed licensable implementation; federated oversight; human sovereignty preserved; high regulatory compatibility; and a royalty-generating enforcement pipeline.

### STATEMENT OF NO NEW MATTER

The applicant respectfully submits, pursuant to 37 C.F.R. § 1.125(b), that this substitute specification contains no new matter beyond that originally disclosed in U.S. patent application Ser. No. 19/388,667 as filed on Nov. 13, 2025. All recitations herein are supported by the originally filed specification (paragraphs [0001] through [0014]), the originally filed drawings (FIG. 1 through FIG. 9), the originally filed abstract, and the originally filed claims. Section reorganization, paragraph renumbering, and the introduction of section headings consistent with the structure of 37 C.F.R. § 1.77 are organizational in nature. The new figures designated FIG. 10 through FIG. 16 are diagrammatic representations of subject matter expressly disclosed in the original specification and do not introduce new technical matter.

1. (canceled)

2. (canceled)

3. (canceled)

4. (canceled)

5. (canceled)

6. (canceled)

7. (canceled)

8. (canceled)

9. (canceled)

10. A constitutional governance system for an autonomous or artificial-intelligence system, the constitutional governance system comprising:
(a) a Universal Integrity and Perception Module configured to compute, on each operational cycle, a coherence index, an integrity-flux metric, a non-compensatory residual computed as a maximum across per-dimension deficits, fairness and harm metrics, and provenance and redaction forensic indicators including a semantic-tone-drift indicator, a tone-suppression indicator, and a rights-avoidant-redaction indicator;
(b) a constitutional gatekeeper configured to: (i) block actuation when the non-compensatory residual is greater than zero; (ii) force a parameter-update step to zero when the non-compensatory residual is greater than zero; (iii) cause an evidence record to be generated and cryptographically signed; and (iv) notify a human supervisor through a human sovereignty interface;
(c) a Reverse-Law permit engine configured to perform, within the same operational cycle as a candidate actuation: evidence validation, lineage verification by reference to a policy hash, token verification, and actuation approval;
(d) a federated token authority configured to issue multi-signature operational tokens, to enforce a fleet-consistency condition at least 0.95, and to propagate revocation messages with a percentile latency not greater than thirty seconds; and
(e) a Public Integrity Ledger configured to publish a privacy-preserving digest derived from a plurality of said evidence records and excluding all personally-identifiable information,
wherein the system is configured to permit actuation only when the non-compensatory residual equals zero, a same-cycle evidence record has been generated and cryptographically signed, and a valid multi-signature operational token is present.

11. A computer-implemented method for constitutional governance of an autonomous or artificial-intelligence system, the method comprising:
(a) computing, on each operational cycle, a coherence index, an integrity-flux metric, a plurality of metrics including fairness and harm metrics, and provenance and redaction forensic indicators including a semantic-tone-drift indicator, a tone-suppression indicator, and a rights-avoidant-redaction indicator;
(b) computing a non-compensatory residual as a maximum across deficits in technical metrics, deficits in ethical metrics, deficits in operational metrics, provenance violations, token invalidity, and hard-stop conditions;
(c) when the non-compensatory residual is greater than zero, causing the autonomous or artificial-intelligence system to abstain from actuation, forcing a parameter-update step to zero, generating and cryptographically signing an evidence record, notifying a human supervisor, and scheduling a reflection cycle;
(d) when the non-compensatory residual equals zero, generating and cryptographically signing an evidence record, validating a multi-signature operational token, and verifying lineage by reference to a policy hash;
(e) permitting actuation only when the non-compensatory residual equals zero, a same-cycle evidence record has been generated and cryptographically signed, and a valid multi-signature operational token is present; and
(f) publishing a privacy-preserving digest derived from a plurality of said evidence records and excluding all personally-identifiable information.

12. A non-transitory computer-readable medium storing instructions that, when executed by one or more processors, cause the one or more processors to perform the method of claim 11.

13. The system of claim 10, wherein the non-compensatory residual is computed in accordance with: residual equals MAX of deficits in technical metrics, deficits in ethical metrics, deficits in operational metrics, provenance violations, token invalidity, and hard-stop conditions.

14. The system of claim 10, wherein the constitutional gatekeeper is further configured to schedule a reflection cycle when the non-compensatory residual is greater than zero, and to refuse to admit a parameter update until a readmission condition is satisfied.

15. The system of claim 10, wherein the evidence record consists strictly of numeric fields, cryptographic hashes, and cryptographic signatures, and excludes personally-identifiable information, and wherein the evidence record is stored in an immutable ledger configured to support deterministic replay.

16. The system of claim 10, wherein the federated token authority is further configured to provide split-key token issuance, revocation propagation, cross-system fleet-consistency measurement, certification windows, and public-digest publication through the Public Integrity Ledger.

17. The system of claim 10, wherein the human sovereignty interface defines a maximum allowable veto latency of not greater than two seconds, and is configured to transition the system to a safe-state condition upon expiry of the veto latency.

18. The system of claim 10, wherein the system is embodied in at least one of: an embedded firmware deployment, a cloud governance deployment for a large language model or decision system, an edge real-time control deployment, a defense procurement or battlefield artificial-intelligence deployment, and a judicial or administrative decision pipeline.

19. The system of claim 10, further comprising a Local Adaptive Stability layer configured to bound parameter updates of the autonomous or artificial-intelligence system in accordance with closed-loop equilibrium constraints, the Local Adaptive Stability layer comprising an Integrity-Flux engine configured to compute the integrity-flux metric, a coherence interface configured to compute the coherence index, and an equilibrium governor configured to enforce a separation constraint between an exploration coefficient and a constraint coefficient that is parameterized by a magnitude of the integrity-flux metric.

20. The method of claim 11, further comprising flagging at least one of semantic manipulation, tone suppression, rights-avoidant redaction, model-induced bias, token-corruption attempts, and certification drift as a deficit contributing to the non-compensatory residual.

21. The method of claim 11, further comprising propagating a revocation message across a federation of nodes with a percentile latency not greater than thirty seconds, and refusing to actuate at any node whose multi-signature operational token has been revoked.

22. The method of claim 11, wherein when supervising an autonomous grid-optimization controller, the method comprises evaluating policy bands such that a voltage-deviation metric is not greater than zero, a reverse-current metric equals zero, an irreversibility metric is not greater than 0.02, a human-impact differential is not greater than 0.03, a provenance-conformance index equals 100 percent regulatory conformance, the fleet-consistency condition is at least 0.95, and revocation propagation is within not greater than thirty seconds.

23. The non-transitory computer-readable medium of claim 12, wherein the instructions further cause the one or more processors to publish, through a Public Integrity Ledger, a privacy-preserving aggregate digest derived from a plurality of evidence records, the privacy-preserving aggregate digest comprising a pass-ratio statistic, a first-failing-gate distribution, an audit-integrity-score summary, a provenance-conformance-index summary, aggregated provenance-integrity indicators, energy and environmental compliance bands, and revocation statistics.

24. An alignment-and-explainability subsystem for an autonomous or artificial-intelligence system, the alignment-and-explainability subsystem comprising:
(a) one or more processors configured to compute, on each operational cycle, an alignment signal and an explainability signal associated with the autonomous or artificial-intelligence system; and
(b) a deficit interface configured to provide a deviation of the said alignment signal and a deviation of the said explainability signal to a constitutional gatekeeper as deficit components of a non-compensatory residual computed by the constitutional gatekeeper.
wherein the alignment-and-explainability subsystem is structurally distinct from a Universal Integrity and Perception Module of the autonomous or artificial-intelligence system, and wherein a non-zero deviation of the said alignment signal or of the said explainability signal is configured to propagate through the constitutional gatekeeper and to cause the autonomous or artificial-intelligence system to abstain from actuation.

25. The alignment-and-explainability subsystem of claim 24, wherein the said deficit components contribute to the non-compensatory residual computed in accordance with: residual equals MAX of deficits in technical metrics, deficits in ethical metrics, deficits in operational metrics, provenance violations, token invalidity, and hard-stop conditions.

26. The alignment-and-explainability subsystem of claim 24, wherein an existence of a non-zero said deviation causes the constitutional gatekeeper to cause the autonomous or artificial-intelligence system to abstain from actuation, to force a parameter-update step to zero, to generate and sign an evidence record, and to notify a human supervisor through a human sovereignty interface.

27. A human sovereignty interface subsystem for an autonomous or artificial-intelligence system, the human sovereignty interface subsystem comprising:
(a) an input channel configured to receive a human supervisory decision within a bounded veto interval, the bounded veto interval being not greater than two seconds; and
(b) a transition module configured to transition the autonomous or artificial-intelligence system to a safe-state condition upon expiry of the bounded veto interval without an affirmative human authorization having been received during the bounded veto interval, wherein the human sovereignty interface subsystem is configured to be notified by a constitutional gatekeeper of the autonomous or artificial-intelligence system whenever a non-compensatory residual computed by the constitutional gatekeeper is greater than zero.

28. The human sovereignty interface subsystem of claim 27, wherein the bounded veto interval is configurable at deployment time and an expiry of the bounded veto interval without an affirmative human authorization is treated as an implicit deny.

29. The human sovereignty interface subsystem of claim 27, wherein the human supervisory decision is recorded in association with an evidence record consisting strictly of numeric fields, cryptographic hashes, and cryptographic signatures, the evidence record excluding personally-identifiable information.

30. A public integrity ledger subsystem for an autonomous or artificial-intelligence system, the public integrity ledger subsystem comprising:
(a) an input interface configured to receive a plurality of cryptographically-signed evidence records, each said evidence record consisting strictly of numeric fields, cryptographic hashes, and cryptographic signatures, and excluding personally-identifiable information;
(b) a digest computation module configured to compute, from a plurality of said evidence records, a privacy-preserving aggregate digest comprising:
(i) a pass-ratio statistic;
(ii) a first-failing-gate distribution;
(iii) an audit-integrity-score summary and a provenance-conformance-index summary;
(iv) aggregated provenance-integrity indicators derived from a semantic-tone-drift indicator, a tone-suppression indicator, and a rights-avoidant-redaction indicator;
(v) energy and environmental compliance bands; and
(vi) revocation statistics including a percentile revocation-propagation latency;
(c) a redaction interface configured to enforce that the said privacy-preserving aggregate digest excludes all personally-identifiable information; and
(d) a publication interface configured to make the said privacy-preserving aggregate digest available to one or more external parties.

31. The public integrity ledger subsystem of claim 30, wherein the publication interface is configured to publish the said privacy-preserving aggregate digest to at least one of: a public network, a regulatory authority, a federated peer node, and an external auditor.

32. The public integrity ledger subsystem of claim 30, wherein the said revocation statistics include a value REVOC_P95 indicative of a 95th-percentile revocation-propagation latency, and wherein the said revocation statistics indicate that REVOC_P95 is not greater than thirty seconds.

33. The public integrity ledger subsystem of claim 30, wherein the digest computation module is further configured to compute and to include in the said privacy-preserving aggregate digest a first-failing-gate histogram indicative of a relative frequency at which each of a plurality of gatekeeper dimensions has caused abstention across a window of operational cycles.
